(19) United States
(12) Patent Application Publication
(10) Pub. No.: US 2014/0135208 A1
(43) Pub. Date: May 15, 2014

(54) INCREASED LIFETIME PREREFORMER CATALYST

(71) Applicant: L'AIR LIQUIDE SOCIETE ANONYME POUR I'ETUDE ET I'E, Paris (FR)

(72) Inventors: Daniel Gary, Houston, TX (US); Pavol Pranda, Hockessin (DE); Tony Mathew Thampan, Bear (DE)

(73) Assignee: L'Air Liquide Societe Anonyme Pour I'Etude et I'Expoitation des Procedes Georges Claude, Paris (FR)

(21) Appl. No.: 13/676,267

(22) Filed: Nov. 14, 2012

(51) Int. Cl. B01J 35/10; B01J 23/02; B01J 21/02; B01J 23/89; B01J 23/26; B01J 21/06; B01J 23/755; B01J 23/04; B01J 35/02; B01J 23/10

(52) U.S. Cl. 502/303; 502/100; 502/341; 502/355; 502/306; 502/320; 502/349; 502/337; 502/344; 502/326; 502/330

(57) ABSTRACT

The present invention a catalyst that includes a metallic or ceramic foam catalyst support having surfaces within the foam for the placement of a catalytic material, and an active catalyst material which is applied by washcoating or dipping.

### BACKGROUND

Hydrogen is manufactured for use in a wide variety of processes including hydrocracking-hydrotreating in petroleum refining, the manufacture of fine chemical products, as a raw material in the synthesis of ammonia and methanol, as an energy carrier in the space industry, and in an increasing number of demonstration projects for cars and buses fleets. Currently, 85% of the hydrogen manufactured on a worldwide basis is consumed by refineries (excluding the ammonia and methanol industries) and only a fraction of the hydrogen required by refineries is generated by the catalytic reforming process (producing high-octane gasoline). The remainder has to be generated by a supplementary hydrogen production facility. For this supplementary hydrogen production, on average 90% is generated by steam hydrocarbon reforming (hereinafter “SHR”) of hydrocarbon feed streams, of which steam methane reforming (hereinafter “SMR”) is the most utilized. In this process, heterogeneous nickel catalysts are the most commonly used catalysts for the treatment of the hydrocarbon feed streams. Due to the higher hydrocarbon content in refinery off-gas, and the natural gas becoming heavier recently, the installation of pre-reformers are increasing thereby making pre-reforming of the hydrocarbon feed streams an important step in the SHR process scheme.

In the pre-reformer, long chain (higher) hydrocarbons are converted by the steam reforming reaction to produce a mixture that includes hydrogen, carbon dioxide, carbon monoxide and methane. What has been found it that there are a number of benefits to installing a pre-reformer, including increasing production capacity, decreasing the size of the reformer furnace, feedstock flexibility, increased catalyst lifetime in the SHR unit, increased tube life in the SHR unit, a decrease in carbon formation and hot band in tubular reformers, an increase in advanced processes featuring low energy consumption and investment.

The present state of the art technology is Ni supported catalyst with a high loading in order to increase catalyst activity at low temperature. However the resulting metal dispersion is low (˜2-3 wt %) meaning only 2-3% of the nickel atoms are accessible to reactants. Depending upon the feed and operating conditions, the present state of the art catalyst is also limited to a lifetime of ˜3 years. Conventional pre-reformer catalyst is made of tabletized or pelletized ceramic powder having cylindrical shape with no up to 7 holes. Catalyst supported on foam is not part of a conventional pre-reformer. There is a need in the industry for a more effective pre-reformer catalyst, with a longer useful lifetime.

### SUMMARY

The present invention a catalyst that includes a metallic or ceramic foam catalyst support having surfaces within the foam for the placement of a catalytic material, and an active catalyst material which is applied by washcoating or dipping.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention may be used to retrofit a conventional reactor or deployment in standard pre-reformer reactor at standard gas hourly space velocity (GHSV). It is known that poison in the feed (for example sulfur) can act as pore mouth poisons that dramatically affect catalyst activity. Also, commercially available pre-reforming catalysts exhibit relatively low nickel dispersion (typically 2-4%). One aspect of the present invention is to increase number of pores and at the same time nickel dispersion, thereby increasing the availability of geometric surface area by increasing the number of pores.

The present invention increases the number of nickel atoms available for gas reactants employing the catalyst supported on a metallic/ceramic foam. The increased geometric surface area and high dispersion of nickel on wash coated foam allows the catalyst to provide a longer lifetime vs. conventional catalyst, thus providing increased reliability and lower total plant ownership costs.

Additionally the foam provides a lower pressure drop versus the standard catalyst. The present invention may be applied to the pre-reforming of a feed used in the suitable technologies leading to H₂ production (SMR, TCR . . . ) by solving specific problems of the current pre-reformer reactor. The current design of the pre-reformer reactor consists of: macro voids between the pellets (up to some mm) and micro voids (Macro/Meso/Micro pores of catalyst pellet shaping)

Such designs do not offer the best and most efficient contact between the reacting fluids and the active catalytic sites of the pellet. The poor thermal conductivity of the current ceramic structure (bulk) may cause local over heating—hot spots (due to high local content of CO₂ and/or exothermic methanation reaction). This poor thermal conductivity may also create local under heating due to high local content of C2+ hydrocarbons resulting in high demand for heat causing significant temperature drop.

The optimal catalyst performance is achieved if the flow is equally distributed in the pores, without preferential routes; the flow is turbulent everywhere; the pressure drop is minimal; the fluid has an easy access to the catalyst particulates; the catalyst surface/volume ratio is high; and the radial temperature profile is uniform as possible. The current structure does not fully satisfy these conditions. The open structure (macro voids) created by the random filling of the pellets results in highly dispersed pore size distribution. The flow through the pore is not uniform. And the reactant diffusion through the microporosity of the ceramic pellets limits the efficiency of the catalyst.

The present invention utilizes foam structure (ceramic or metallic) in adiabatic reactor which leads to smoother temperature gradients caused by the catalytic reactions due to high and non randomly distributed porosity creating turbulent flow field with low pressure drop. The high convection effect contributes to homogenize temperature inside the bed.

After obtaining a foam structure, the foam is wash coated by a thin catalyst bearing layer (active phase) leading to an easy access of the reactants. Catalytic foam structure advantages are in high porosity structure close or greater than 96% (current bed porosity—macro voids—close to 50%). The porosity of the material could be tuned between 5 up to 30 ppi (pores per inch); high geometric surface/volume ratio (greater than 10000 m²/m³, ˜400 m²/m³ for pellets, almost two times more than a current pellet void space; and very thin catalytic layer (few μm up to ten^{th} μm) with highly dispersed well anchored nickel.

In this way the required amount of active metal is lower than commercial loads in the 40-50 wt % range. Generally for foam like material active metal deposits are in the 15/20 wt % range. The savings may also justify the addition of precious metal creating bimetallic formulation (Ni/Rh, Ni/Pt, etc. and even cheaper Ni/Ag). Due to higher geometric surface area potential benefits are as follows: higher space velocity, the catalytic foam increases the productivity of the plant; and at current working conditions, the catalytic foam increases the life time (time on stream) of the load versus pellet shaping.

The catalytic foam wash coated by a bi-metallic phase (Ni/Rh, Ni/Pt, Ni/Ag, etc.) will be more resistant to poisoning or coking contributing to an increase of the life time of the catalytic foam vs pellet shaping. Another advantage of the catalytic foam relates to the fact that at high temperature (i.e. reforming carried out at 600-650° C.) the catalyst would be more resistant than current pellet due to foam structure locally minimizing the over-heating and by lowering the amount of Ni. This shaping is more stable at high temperature. By increasing the geometric surface area it is possible to decrease the catalytic load which is favorable for the dispersion of the active phase resulting in higher metal surface area with small catalytic particles. Small catalytic particles if drafted/anchored properly on the support present higher thermal stability and lower tendency to sintering than bigger catalytic particles. Another way to improve the thermal stability of the support is addition/doping with high temperature resistant oxides like ceria, lanthana or zirconia. On the other side, the addition of these oxides leads to higher acidity of the support and higher probability of coking.

The benefits of the present invention include higher poison resistance, lower pressure drop, better heat distribution, easier loading and unloading, and better thermal stability.

What is claimed is:

1: A catalyst comprising: a foam catalyst support having surfaces within the foam for the placement of a catalytic material, and an active catalyst material which is applied by washcoating or dipping.

2. The catalyst of claim 1, wherein said foam catalyst support is ceramic.

3: The catalyst of claim 1, wherein said foam catalyst support is metallic.

4: The catalyst of claim 1, wherein said catalyst support has a Geometric Surface Area greater than 30,000 m²/m³.

5: The catalyst of claim 4, wherein said catalyst support has a Geometric Surface Area greater than 40,000 m²/m³.

6: The catalyst of claim 5, wherein said catalyst support has a Geometric Surface Area greater than 50,000 m²/m³.

7: The catalyst of claim 1, wherein said catalyst is shaped to provide a BET area of at least 6.5 m²/g.

8: The catalyst of claim 7, wherein said catalyst is shaped to provide a BET area of at least 10 m²/g.

9: The catalyst of claim 1, wherein said active catalyst comprises anti-blocking elements like MgAl₂O₄ , CaAl₂O₄or other base metal aluminate.

10: The catalyst of claim 9, wherein said active catalyst further comprises at least one of ZrO₂ CrO₂, or La₂O₃.

11: The catalyst of claim 1, wherein said catalyst support is cylindrically shaped.

12: The catalyst of claim 1, wherein said active catalyst comprises nickel having dispersion greater than 4%.

13: The catalyst of claim 1, wherein said active catalyst is doped by potassium oxide greater than 0.5% wt to minimize carbon formation.

14: The catalyst of claim 1, wherein said active catalyst is doped by potassium oxide 8% wt.

15: The catalyst of claim 1, wherein said foam catalyst support has a porosity structure of greater than 96%.

16: The catalyst of claim 1, wherein foam catalyst support has a porosity of between 5 and 30 pores per inch.

17: The catalyst of claim 1, wherein said active catalyst material deposits are between 15 and 20% wt.

18: The catalyst of claim 1, wherein said active catalyst material may include bi-metallic formulations selected from the group consisting of Ni/Rh, Ni/Pt and Ni/Ag.
